(19) United States
(12) Patent Application Publication
(10) Pub. No.: US 2020/0052255 A1
(43) Pub. Date: Feb. 13, 2020

(54) POUCH-TYPE SECONDARY BATTERY MODULE

(71) Applicant: SK INNOVATION CO., LTD., Seoul (KR)

(72) Inventor: Hyun Seok KIM, Daejeon (KR)

(21) Appl. No.: 16/534,610

(22) Filed: Aug. 7, 2019

(30) Foreign Application Priority Data
Aug. 8, 2018 (KR) 10-2018-0092179

(51) Int. Cl. H01M 2/10

(52) U.S. Cl. CPC H01M 2/1061; H01M 2/1077; H01M 2/1094

(57) ABSTRACT

Provided is a pouch-type secondary battery module including: a plurality of unit pouch-type secondary batteries sequentially stacked and each including a folded portion in which an end of a sealing portion is folded; a module case including a cover portion covering the folded portion of the unit pouch-type secondary battery; and a protective member provided between the folded portion of the unit pouch-type secondary battery and the cover portion of the module case, the protective member enclosing the folded portion.

### CROSS-REFERENCE TO RELATED APPLICATIONS

This application claims priority under 35 U.S.C. § 119 to Korean Patent Application No. 10-2018-0092179, filed on Aug. 8, 2018, in the Korean Intellectual Property Office, the disclosure of which is incorporated herein by reference in its entirety.

### TECHNICAL FIELD

The following disclosure relates to a pouch-type secondary battery module.

### BACKGROUND

A lithium secondary battery may be classified into a lithium secondary battery using a liquid electrolyte and a lithium polymer secondary battery using a polymer solid electrolyte depending on the type of an electrolyte.

A lithium secondary battery using a liquid electrolyte may be welded and sealed using a metal can having a cylindrical shape or a prismatic shape as a container. In the case of a secondary battery in which such a metal can is used as a container, its shape is fixed. Thus, the design and miniaturization of an electrical product using the secondary battery as a power source may be restricted. Therefore, a pouch-type secondary battery, which is manufactured by sealing two electrodes, a separator, and an electrolyte in a pouch made of a film, has been developed.

A pouch-type secondary battery which is commonly used is a type in which an electrode assembly including a cathode, an anode, a separator, and an electrolyte, which are housed therein, is enclosed by a pouch, and is sealed at a portion to which a case constituting a pouch is bonded upon assembly.

### SUMMARY

An embodiment of the present invention is directed to providing a pouch-type secondary battery module including a plurality of unit pouch-type secondary batteries capable of stably fixing and protecting the unit battery even when an external impact is applied, and preventing insulation breakdown of a unit pouch-type secondary battery that is vulnerable to insulation breakdown.

In one general aspect, a pouch-type secondary battery module includes a plurality of unit pouch-type secondary batteries sequentially stacked and each including a folded portion in which an end of a sealing portion is folded; a module case including a cover portion covering the folded portion of the unit pouch-type secondary battery; and a protective member provided between the folded portion of the unit pouch-type secondary battery and the cover portion of the module case, the protective member enclosing the folded portion.

The protective member may include rubber, polyurethane foam, commercial plastic, engineering plastic, or a combination thereof.

The protective member may include a mixture of at least one selected from the group of rubber, polyurethane foam, and commercial plastic, and engineering plastic.

The protective member may include 10 to 30% by weight of the engineering plastic, based on 100% by weight of the total amount of at least one selected from the group of rubber, polyurethane foam, and commercial plastic, and engineering plastic.

The sealing portion may be formed perpendicular to a stacking direction of the unit pouch-type secondary battery, and the folded portion may be folded at 60° to 120° with respect to the stacking direction of the unit pouch-type secondary battery in an axis perpendicular to the stacking direction of the unit pouch-type secondary battery.

The rubber may include natural rubber, styrene-butadiene rubber (SBR), acrylonitrile-butadiene rubber (NBR), butyl rubber, or a combination thereof.

The commercial plastic may include polyvinyl chloride, polystyrene, polyethylene terephthalate, polyethylene, polypropylene, or a combination thereof.

The engineering plastic may include polysulfone, polyphenylene sulfide, polyetherimide, polyethersulfone, polyacetal, polyphenylene oxide, or a combination thereof.

Other features and aspects will be apparent from the following detailed description, the drawings, and the claims.

### BRIEF DESCRIPTION OF THE DRAWINGS

FIG. 1 is a schematic diagram of a unit pouch-type secondary battery according to an exemplary embodiment of the present invention.

FIG. 2 is a schematic diagram of a pouch-type secondary battery module according to an exemplary embodiment of the present invention.

FIG. 3 is a schematic diagram of a protective member according to an exemplary embodiment of the present invention.

FIG. 4 is a schematic diagram of a pouch-type secondary battery module according to a comparative embodiment.

[Detailed Description of Main Elements]

| | |
|---|---|
| 1: electrode assembly | 2: first electrode tab |
| 3: second electrode tab | 4: folded portion |
| 10: unit pouch-type secondary battery | |
| 20: protective member | |
| 30: module case | |
| 31: cover portion | |
| 100: pouch-type secondary battery module | |

### DETAILED DESCRIPTION OF EMBODIMENTS

Unless otherwise defined, all terms (including technical and scientific terms) used herein have the general meaning understood by those skilled in the art to which the present invention pertains. Throughout the present specification, unless described to the contrary, “including” any component will be understood to imply the further inclusion of other elements rather than the exclusion of other elements. In addition, unless explicitly described to the contrary, a singular form includes a plural form in the present specification.

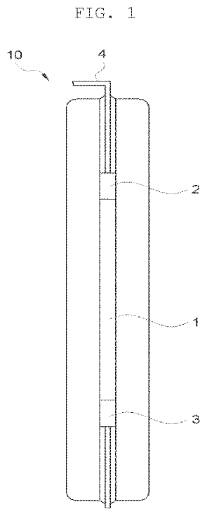

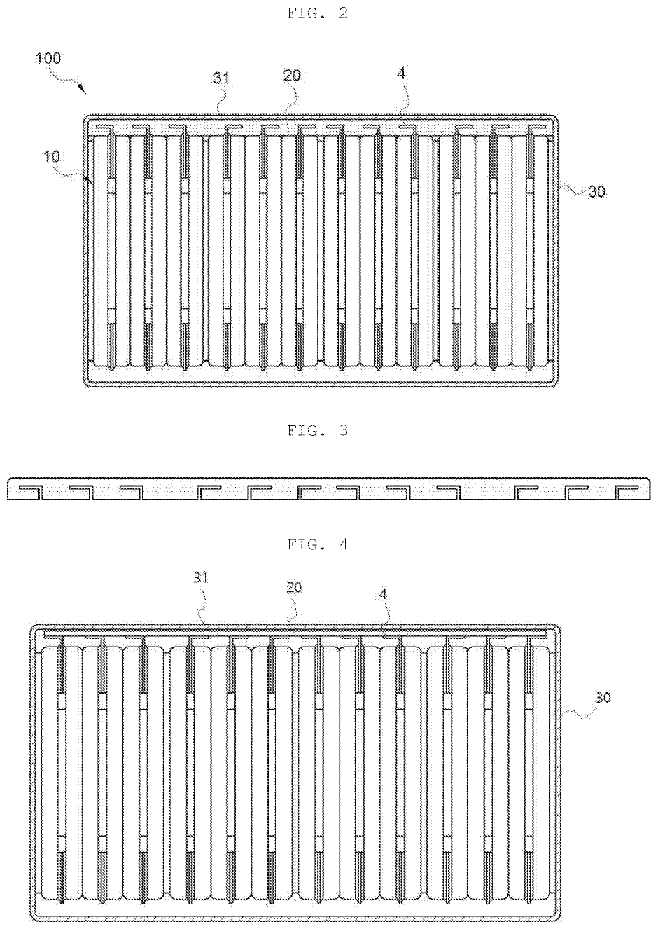

FIG. 1 is a schematic diagram of a unit pouch-type secondary battery according to an exemplary embodiment of the present invention. FIG. 2 is a schematic diagram of a pouch-type secondary battery module according to an exemplary embodiment of the present invention. FIG. 3 is a schematic diagram of a protective member according to an exemplary embodiment of the present invention. FIG. 4 is a schematic diagram of a pouch-type secondary battery module according to a comparative embodiment.

Hereinafter, a pouch-type secondary battery module according to an exemplary embodiment of the present invention will be described with reference to FIGS. 1 to 4. FIGS. 1 to 3 are merely an embodiment of the present invention, and those skilled in the art can freely make modifications within the scope and spirit of the present invention. The present invention is not necessarily limited to the matters shown in FIGS. 1 to 3.

An embodiment of the present invention provides a pouch-type secondary battery module including a plurality of unit pouch-type secondary batteries 10 sequentially stacked and each including a folded portion 4 in which an end of a sealing portion is folded; a module case 30 including a cover portion 31 covering the folded portion 4 of the unit pouch-type secondary battery 10; and a protective member 20 provided between the folded portion 4 of the unit pouch-type secondary battery 10 and the cover portion 31 of the module case 30, the protective member 20 enclosing the folded portion 4.

As an example of a non-aqueous lithium ion secondary battery, the unit pouch-type secondary battery includes a first electrode plate, a second electrode plate, a separator, and an electrolyte, and is manufactured by housing an electrode assembly including a first electrode tab and a second electrode tab which are connected to the first electrode plate and the second electrode plate, respectively, and exposed to the external when the pouch-type secondary battery is assembled, in a case, and then sealing the case. Here, the first electrode and the second electrode may be a cathode and an anode, or an anode and a cathode, respectively.

In this case, the sealing method may be performed by a method of heat fusing an adhesive resin or the like previously applied to the inside of the case.

This aspect is merely an example, and the present invention is not necessarily limited thereto. Other types of secondary batteries and other sealing methods may be adapted without departing from the scope of the present invention.

Materials of a cathode, an anode, a separator, and electrolyte in the secondary battery are also not particularly limited in the present invention, and materials known in the art may be adopted depending on the type of the secondary battery to be adapted. Thus, a detailed description thereof will be omitted.

Detailed configuration of the module case may also be adopted without particular limitation within the scope to which the present invention is applicable. Thus, a detailed description thereof will be omitted.

In such unit pouch-type secondary battery, the sealing portion has a shape protruding to the external of the unit pouch-type secondary battery, whereby the end of the sealing portion may be folded to secure stability such as insulation breakdown.

However, when a plurality of unit pouch-type secondary batteries are modulated, the folded portion 4 folded as described above, may be vulnerable to an external impact, such that the position may be changed or broken when an impact is applied, thereby causing insulation breakdown.

A pouch-type secondary battery module according to an embodiment of the present invention may solve this problem. Specifically, the protective member 20 is provided between the plurality of unit pouch-type secondary batteries 10 sequentially stacked and the module case 30 including the cover portion 31 covering the folded portion 4 of the unit pouch-type secondary battery 10, the protective member 20 enclosing the folded portion 4, thereby protecting the folded portion 4 physically through the protection member 20.

In addition, the impact applied from the external is not locally applied to the folded portion 4 but is dispersed in all directions around the folded portion 4 to mitigate the impact applied to the folded portion 4, thereby firmly fixing the unit pouch-type secondary battery and preventing the insulation breakdown.

Here, the enclosing of the folded portion 4 by the protective member 20 may mean that the protection member 20 is located on the entire outer surfaces of the folded portion 4.

In addition, the state in which protective member 20 is located on the entire outer surfaces includes a state in which the protective member 20 is located on the entire outer surface of the folded portion and a gap is inevitably formed during the manufacturing process.

As a comparative example, as shown in FIG. 4, when the protection member 20 is located only on the upper surface of the folded portion 4 covered with the cover portion 31 of the module case 30, a physical force may be applied to the folded portion 4 during module configuration, and the external impact may not be uniformly dispersed in many directions, such that the folded portion 4 may be broken, and insulation breakdown may occur.

Hereinafter, the material of the protective member 20 will be described.

The protective member 20 may preferably have elasticity so as to absorb an external impact.

Specifically, the protective member 20 may include rubber, polyurethane foam, commercial plastic, engineering plastic, or a combination thereof.

The rubber may include, natural rubber, styrene-butadiene rubber (SBR), acrylonitrile-butadiene rubber (NBR), butyl rubber, or a combination thereof, but the present invention is not limited thereto.

The polyurethane foam may be a soft polyurethane foam known in the art, or may be partially mixed with a soft polyurethane foam and a rigid polyurethane foam, but the present invention is not limited thereto.

The commercial plastic may include polyvinyl chloride, polystyrene, polyethylene terephthalate, polyethylene, polypropylene, or a combination thereof, but the present invention is not limited thereto.

The engineering plastic may include polysulfone, polyphenylene sulfide, polyetherimide, polyethersulfone, polyacetal, polyphenylene oxide, or a combination thereof, but the present invention is not limited thereto.

Meanwhile, the protective member 20 may preferably include a mixture of at least one selected from the group of rubber, polyurethane foam, and commercial plastic, and engineering plastic.

Since the engineering plastic is excellent in strength and heat resistance as compared to rubber, polyurethane foam, and commercial plastic, the strength and heat resistance of the protective member 20 may be improved when blended.

Accordingly, the blending of the engineering plastic may further contribute to the physical protection of the folded portion 4 and improve the heat resistance. Thus, in the case of a rapid ignition due to an abnormal phenomenon or the like of the battery, the stability of the battery and the stability of the device adapting the battery may be improved.

In this case, the blending amount of the engineering plastic may be preferably 10 to 30% by weight, based on 100% by weight of the total amount of at least one selected from the group of rubber, polyurethane foam, and commercial plastic, and engineering plastic.

With such a blending amount, an effect of improving the strength and heat resistance by the engineering plastic may be sufficiently implemented, and the degree of increase in brittleness due to the inclusion of the engineering plastic may be appropriately adjusted.

Accordingly, when the module is subjected to a sudden impact in the longitudinal direction while excellent strength and heat resistance are implemented, the risk of the protective member 20 is broken may also be prevented.

In addition, as a specific mixing type, a matrix of at least one selected from the group of rubber, polyurethane foam, and commercial plastic may be filled with engineering plastics as particulate or fibrous fillers, of the engineering plastic may be blended.

Preferably, a blending resin may be used so that physical properties to be implemented after mixing are more evenly implemented throughout the protective member 20.

Further, the protective member 20 may be separately manufactured and assembled as a part in accordance with the arrangement shape of the folded portion 4 in the module stacked in a separate process during module manufacture.

In addition, in an embodiment of the present invention, the sealing portion of each unit pouch-type secondary battery may all be stacked so as to face in the same direction; the protective member 20 may be manufactured to enclose the folded portions 4 of all of the entire unit pouch-type secondary batteries to be stacked with one protective member 20; and it is possible to manufacture and assemble a plurality parts in a small size so as to enclose folded portions 4 of one or, for example, three to six unit pouch-type secondary batteries.

As the size of the battery module becomes larger, it is advantageous to manufacture and assemble a plurality of parts in a small size so as to enclose folded portions 4 of several unit pouch-type secondary batteries, thereby facilitating the manufacture of parts and improving the process workability.

Meanwhile, the secondary battery module may include an accessory part for monitoring a state of the secondary battery.

Specifically, an accessory part such as a wire harness and a flexible printed circuit board (FPCB) for sensing voltage and temperature or the like of the secondary battery, connecting the secondary battery and the control circuit to prevent overcharge and overdischarge of the battery, and blocking the current when the temperature rises sharply may be provided.

In an embodiment of the present invention, the protective member 20 may include a space in which these accessory parts may be packaged.

When such a space is included, an accessory part such as a wire harness and a flexible printed circuit board (FPCB) may be fixed, and thus the problem such as a wire being twisted may be solved.

The specific shape of this space and the manner of forming the space are not limited to the specific aspect. For example, when the design of the secondary battery module is varied, the protective member may be separately manufactured for each module, and may be manufactured collectively after standardizing the shape of the secondary battery module.

In the pouch-type secondary battery module according to an embodiment of the present invention, the sealing portion may be formed perpendicular to a stacking direction of the unit pouch-type secondary battery, and the folded portion may be folded at 60° to 120° with respect to the stacking direction of the unit pouch-type secondary battery in an axis perpendicular to the stacking direction of the unit pouch-type secondary battery.

The present invention is not necessarily limited thereto. However, it is suitable that the folded portion 4 is folded to the above-mentioned degree in order to prevent the external impact from being intensively applied to a portion of the folded portion 4 and to make the applied impact be distributed in all directions.

According to the pouch-type secondary battery module according to an embodiment of the present invention, the impact applied from the external of the module may be absorbed, such that the unit battery may be protected from an external impact.

Therefore, even when the external impact is applied, the unit battery may be stably fixed and protected, and insulation breakdown of the unit pouch-type secondary battery, which is vulnerable to insulation breakdown, may be prevented.

In addition, the pressure applied to the secondary battery module during the volume expansion of the unit battery due to repetition of charging/discharging may be absorbed, thereby protecting the unit battery and improving stability.

Although the present invention has been described with reference to the exemplary embodiments and the accompanying drawings, the present invention is not limited to the above-mentioned exemplary embodiments but may be variously modified and changed from the above description by those skilled in the art to which the present invention pertains. Therefore, the scope and spirit of the present invention should be understood only by the following claims, and all of the equivalences and equivalent modifications to the claims are intended to fall within the scope and spirit of the present invention.

What is claimed is:

1. A pouch-type secondary battery module, comprising:
a plurality of unit pouch-type secondary batteries sequentially stacked and each including a folded portion in which an end of a sealing portion is folded;
a module case including a cover portion covering the folded portion of the unit pouch-type secondary battery; and
a protective member provided between the folded portion of the unit pouch-type secondary battery and the cover portion of the module case, the protective member enclosing the folded portion.

2. The pouch-type secondary battery module of claim 1, wherein the protective member includes rubber, polyurethane foam, commercial plastic, engineering plastic, or a combination thereof.

3. The pouch-type secondary battery module of claim 1, wherein the protective member includes a mixture of at least one selected from the group of rubber, polyurethane foam, and commercial plastic; and engineering plastic.

4. The pouch-type secondary battery module of claim 3, wherein the protective member includes 10 to 30% by weight of the engineering plastic, based on 100% by weight of the total amount of at least one selected from the group of rubber, polyurethane foam, and commercial plastic; and engineering plastic.

5. The pouch-type secondary battery module of claim 1, wherein the sealing portion is formed perpendicular to a stacking direction of the unit pouch-type secondary battery, and the folded portion is folded at 60° to 120° with respect to the stacking direction of the unit pouch-type secondary battery in an axis perpendicular to the stacking direction of the unit pouch-type secondary battery.

6. The pouch-type secondary battery module of claim 2, wherein the rubber includes natural rubber, styrene-butadiene rubber (SBR), acrylonitrile-butadiene rubber (NBR), butyl rubber, or a combination thereof.

7. The pouch-type secondary battery module of claim 2, wherein the commercial plastic includes polyvinyl chloride, polystyrene, polyethylene terephthalate, polyethylene, polypropylene, or a combination thereof.

8. The pouch-type secondary battery module of claim 2, wherein the engineering plastic includes polysulfone, polyphenylene sulfide, polyetherimide, polyethersulfone, polyacetal, polyphenylene oxide, or a combination thereof.

9. The pouch-type secondary battery module of claim 1, wherein the protective member includes a space in which a part for monitoring a state of the unit pouch-type secondary battery is packaged.
